(19) United States
(12) Patent Application Publication
(10) Pub. No.: US 2008/0087212 A1
(43) Pub. Date: Apr. 17, 2008

(54) Cabbie caller illuminated signaling device

(76) Inventors: Raul Diaz, New York, NY (US); Estyne Del Rio-Diaz, New York, NY (US)

Correspondence Address: Raul Diaz, Suite 6B, 30 East End Avenue, New York, NY, 10028, US

(21) Appl. No.: 11/284,052

(22) Filed: Nov. 22, 2005

(51) Int. Cl. F21S 10/00

(52) U.S. Cl. 116/202; 116/200

(57) ABSTRACT

The Cabbie Caller is an illuminated signal, specifically used to hail a taxi cab or vehicle for hire. It is a black, hand held device that emits a strong, high visibility blinking orange light. It replaces a chaotic, inefficient, unsafe mode of hailing a taxi, and provides significant safety, social, communication, environmental, and economic benefits to the people using it and to their communities.

### BACKGROUND AND BRIEF SUMMARY OF INVENTION

The Cabbie Caller is an illuminated signal used to hail a taxi cab or vehicle for hire. It is a black, hand held device that emits a strong, high visibility blinking orange light. Night visibility is four city blocks.

### DETAILED DESCRIPTION OF THE INVENTION

The Cabbie Caller is a hand held, illuminated signal used by an individual to hail a taxi, that is water resistant, suitable to signaling taxis in inclement weather, and resistant to accidental drops in puddles. It is battery operated. It is turned on and off by the user, via a green button shaped switch on the back of the device. The words “Cabbie Caller” with an ornamental handshake logo underneath them, are on the front of the device, in orange, at the bottom, in the same orange color as the strobe light pulsing at the top of the device, when turned on.

The handshake is indicative of the mission of Products That Help People, L.L.C., the company formed by the three above named inventors and designer, in order to market the Cabbie Caller to the people, in the interest of public safety, environmental improvements to communities, and economic advantages for all concerned, including the vehicle for hire industry.

### CROSS REFERENCE TO RELATED APPLICATIONS

Patent Search on “taxi hailing device” or “taxi signaling device”: U.S. Pat. Nos. 6,334,697; 5,001,455; Inventor Raul Diaz (formerly under Raul Diaz a.k.a. Juan Francisco) was issued former design patents: Nov. 13, 1990, U.S. DES. 312,055; Dec. 12, 1990, U.S. DES. 313,194, U.S. DES 313,193; Sep. 29, 1992, U.S. DES 329,824, U.S. DES 329,822, U.S. DES 329,823, Japanese Patent 907116; Products That Help People, L.L.C. Design patent applied for, Cabbie Caller name with handshake logo trademark applied for.

### STATEMENT REGARDING FEDERALLY SPONSORED R AND D

There is none.

### REFERENCE TO SEQUENCE LISTING, A TABLE, OR A COMPUTER PROGRAM LISTING COMPACT DISC

Not Applicable.

### DESCRIPTION OF THE FIGURES OF THE DRAWINGS

Disclosure of the Entire Article: We, Raul Diaz, President and Estyne Del Rio-Diaz, Ph.D., Vice-President of Products That Help People, L.L.C. have invented a new design for a Cabbie Caller, as set forth in the following specification by Secretary-Treasurer of Products That Help People, L.L.C., and designer James Wickstead, of James Wickstead Design Associates. Mr. James Wickstead is also Secretary-Treasurer of Products that Help People, L.L.C., the limited Liability company formed with inventors and President Raul Diaz and Vice-President Estyne Del Rio-Diaz, Ph.D., to produce a prototype and market the Cabbie Caller.

FIG. 1 is a front, side, and back view, with dimensions in inches noted on it The front view shows the Cabbie Caller handshake logo, for which a trademark has been applied for.

FIG. 2 is a view of the inside of the Cabbie Caller showing the construction of the bottom half containing the batteries (three triple AAAs), the three batteries, and the top that closes the Cabbie Caller, covering the batteries and containing the green on-off switch on the back of the Cabbie Caller.

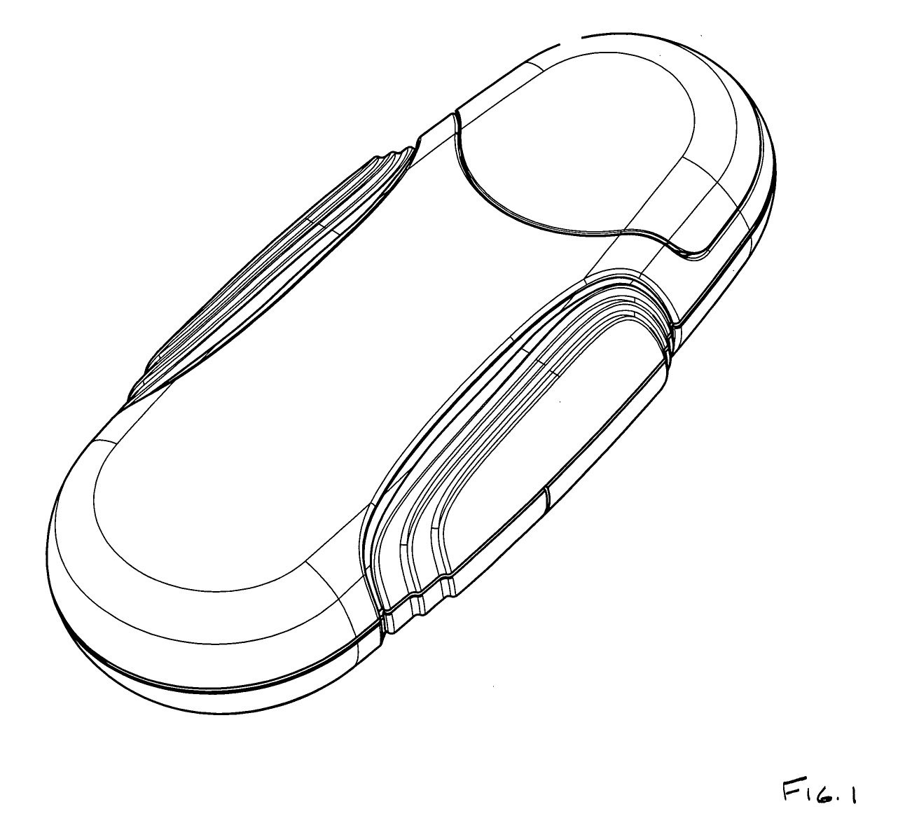

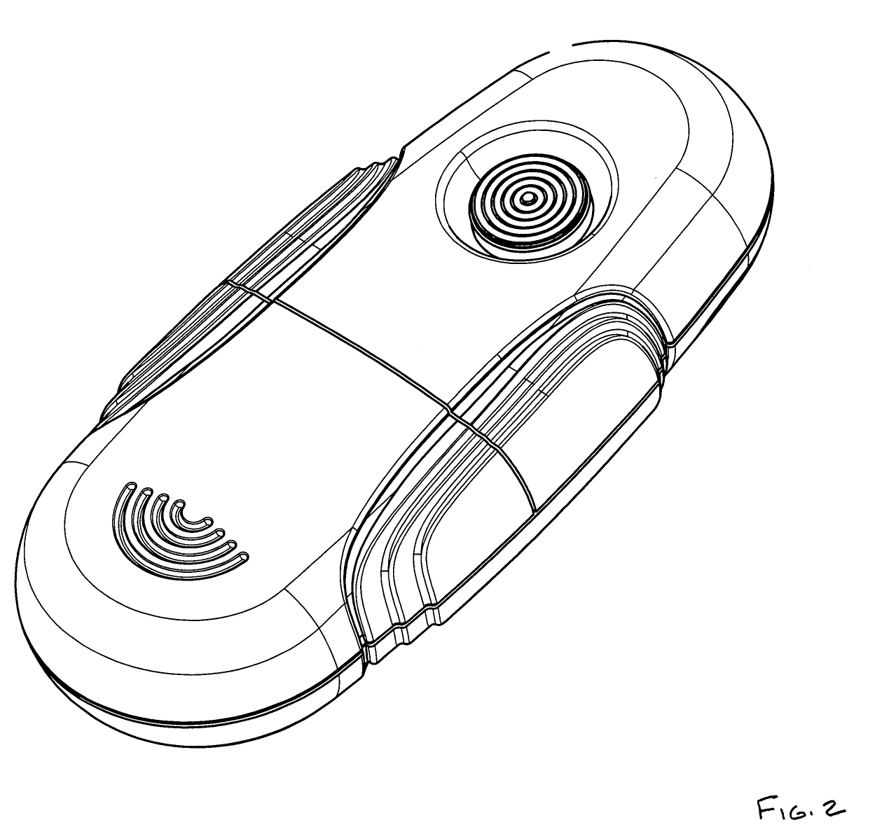

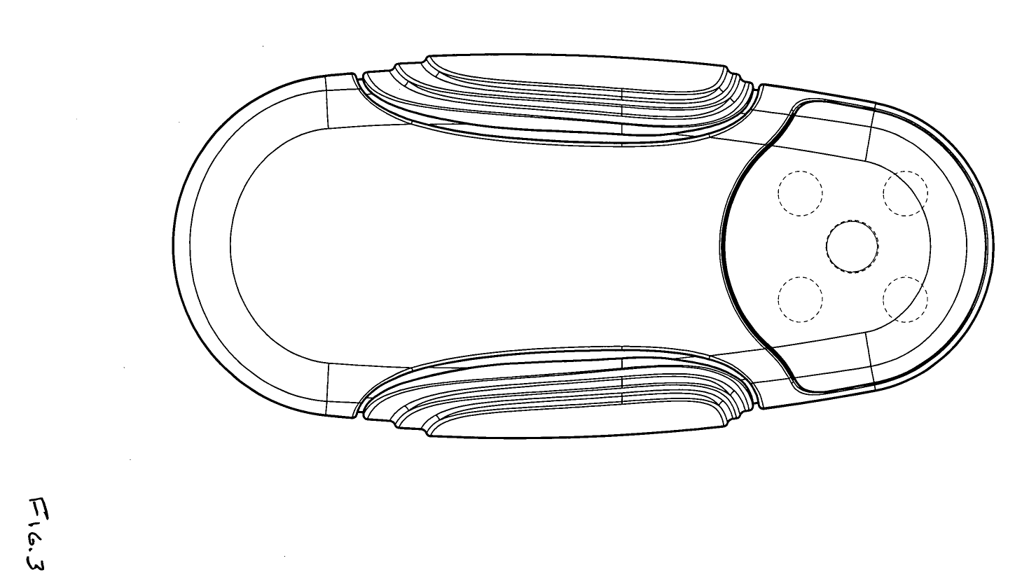

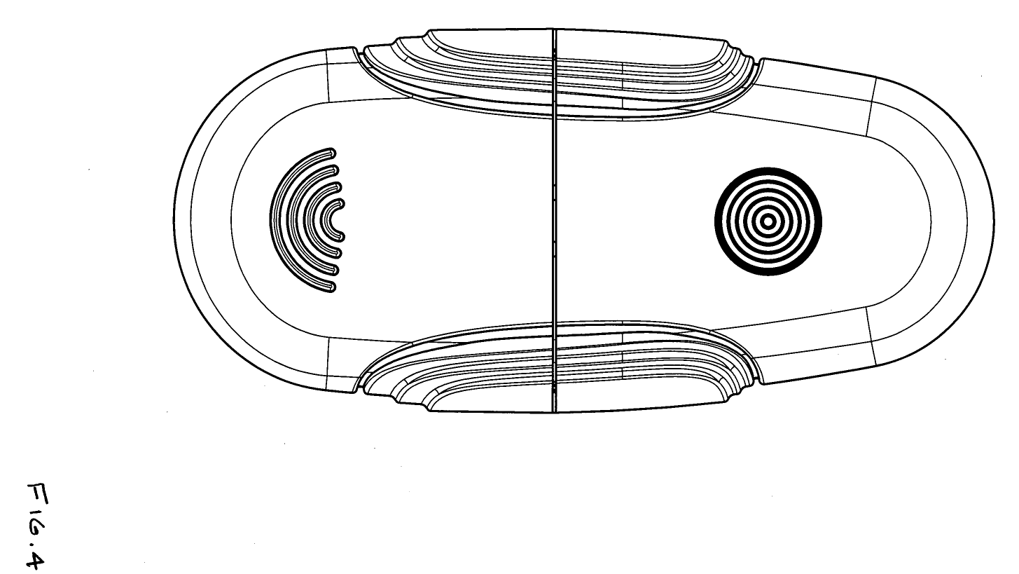

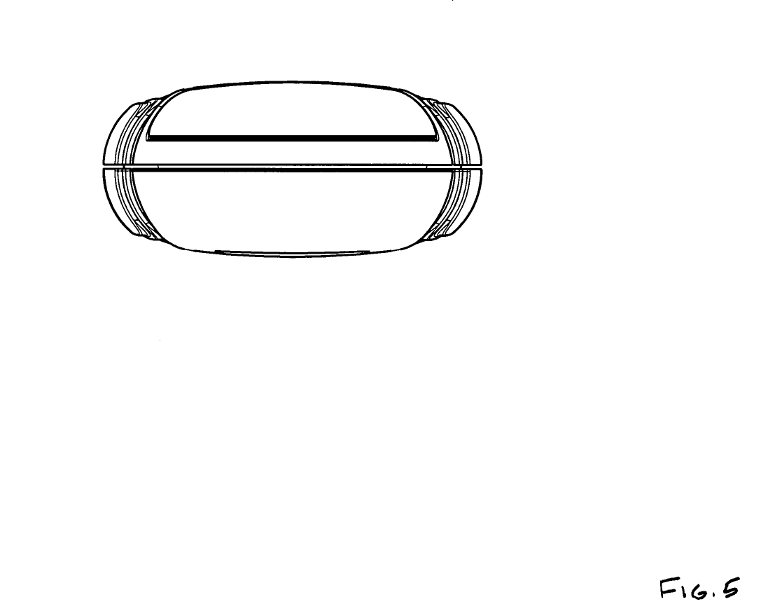

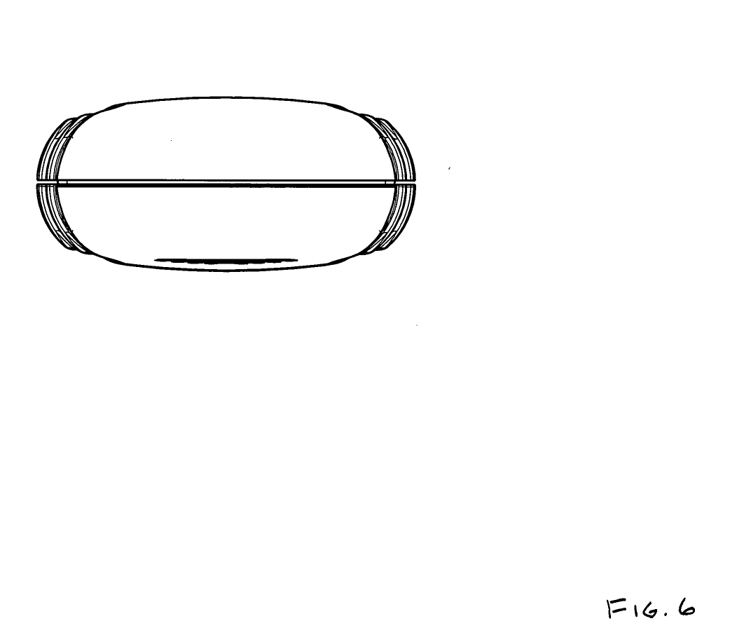

We, Raul Diaz and Estyne Del Rio-Diaz, Ph.D., Principal and Secondary Inventors, claim the ornamental design for the Cabbie Caller, as shown in FIGS. 1 through 2 below.

### FEATURE DESCRIPTION

This invention will dramatically save lives, ease traffic, aid the vehicle for hire industry, reduce wrongful death and other lawsuits from accidents, and increase metropolitan communication among those who drive around the taxis, as well as the taxi drivers and their potential passengers. Mothers with children, the elderly, the disabled, and the handicapped will be able to stay on the sidewalk to signal a cab, and not be overlooked.

This invention has high public safety factor and its patent company's name embodies the ergonomic spirit behind this product. Its streamlined design will help to streamline traffic and vehicle activity in metropolitan areas for the greater public safety and its resultant economic benefit to both individuals and the community.

The Cabbie Caller, being quiet when in operation, will also reduce urban environmental noise level problems, by eliminating noisier methods of taxi hailing, particularly at night when people are sleeping. The use of the Cabbie Caller is not limited to urban areas, e.g., suburbanites also need a good way to signal vehicles for hire across large distances. The Cabbie Caller was invented for this purpose and use. The orange color claimed for the blinking five LED light signal is the same color orange known to and common in the yellow and medallion taxi industry. The use is an integral part of this invention. The Cabbie Caller as an illuminated signal cannot be separated from its purpose to hail a taxi. The element of education, i.e., the public must be educated as to the use and meaning of this signal, as well as the vehicle for hire industry, necessitates a utility patent, which logically follows from the intended use of the invention itself, as well as the intended benefits to the people and the communities who use it. Its concept cannot be separated from its use.

What is claimed is:

1. Primary Inventor Raul Diaz and Secondary Inventor Estyne Del Rio-Diaz, Ph.D., claim the ornamental design for the Cabbie Caller, with logo, as shown and described above for their company Products That Help People, L.L.C., whose Designer and Secretary-Treasurer is James Wickstead. Separate Design Patent and Trademark Applications have been submitted.

2. Primary Inventor Raul Diaz and Secondary Inventor Estyne Del Rio-Diaz Ph.D., claim herein the Utility patent for signaling a vehicle for hire for the Cabbie Caller invention, as shown and described above, for their company Products That Help People, L.L.C., whose Designer and Secretary Treasurer is James Wickstead. This product was invented specifically for this use and for no other use. In addition, the use of this invention to signal vehicles for hire replaces a chaotic, inefficient, outdated mode of hailing a taxi, and provides significant safety, social, communication, environmental, and economic benefits to the people and their communities as described above. In addition, that this product requires the public and vehicle for hire industry to be educated as to its use, and the claim of the orange color associated with the yellow cab industry logically lead to the necessity of a utility patent. Finally, the Primary Inventor has provided herein proof that he had the idea for the cabbie caller in 1990, when he was issued design patents and one Japanese patent as described above.

3. The patent or application file contains at least one drawing executed in color. The color as described herein, a black device, with a high (long range) visibility, five LED orange blinking light and green on/off button, is the color claimed, with the orange Cabbie Caller handshake logo on the bottom front of the device. Copies of the patent or patent applications with color drawings will be provided by the office upon request and payment of the necessary fee.
